(19) United States
(12) Patent Application Publication
(10) Pub. No.: US 2011/0084226 A1
(43) Pub. Date: Apr. 14, 2011

(54) FULL STRAIGHT-SHAFT SEALING BUTTERFLY VALVE

(75) Inventors: Laurie Fowler, Apache Junction, AZ (US); Joe Sega, Phoenix, AZ (US); Donald Farenga, Scottsdale, AZ (US); Micah S. Abel, Gilbert, AZ (US); Paul Banta, Avondale, AZ (US); Doug Smith, Phoenix, AZ (US); Ronald Louis, Phoenix, AZ (US); Ed Dismukes, Chandler, AZ (US)

(73) Assignee: Honeywell International Inc., Morristown, NJ (US)

(21) Appl. No.: 12/577,533

(22) Filed: Oct. 12, 2009

(51) Int. Cl. F16K 1/22

(52) U.S. Cl. 251/305; 251/304

(57) ABSTRACT

A straight shaft sealing valve assembly includes a valve body, a shaft, a valve element, and a seal element. The valve body has an inner surface that defines a flow channel. The shaft is rotationally mounted on the valve body and extends across the flow channel. The shaft includes a first seal opening and a second seal opening. The first and second seal openings are spaced apart from each other and extend through the shaft. The valve element is coupled to the shaft and is rotatable therewith, and has an outer periphery. The seal element is coupled to the valve element, extends from the outer periphery, and extends through the first and second seal openings.

### TECHNICAL FIELD

The present invention generally relates to valves, and more particularly relates to butterfly valves with an improved seal arrangement for straight shaft configurations.

### BACKGROUND

Valves are used in myriad systems to control the flow of a fluid. One particular system in which valves are used is an aircraft bleed air system. As is generally known, a portion of the compressed air generated by an aircraft gas turbine engine, which may be either a main propulsion engine or an auxiliary power unit, may be selectively routed to one or more pneumatic loads. Typically, this selective routing of bleed air to one or more pneumatic loads is controlled via one or more bleed air valves.

Bleed air valves may be variously configured. One exemplary type of valve that is used is a butterfly valve. A butterfly valve typically includes a valve body and a butterfly plate. The valve body includes an inner surface that defines a flow channel. The butterfly plate is mounted on a shaft and disposed within the flow channel. An actuation mechanism is coupled to the shaft and, upon supplying a torque to the shaft, causes the butterfly to rotate between a closed position and a plurality of open positions. The configuration of the butterfly plate and shaft are such that, at least for low-leakage and relatively high-pressure applications such as bleed air systems, the shaft is arranged to extend through the butterfly plate and across the flow channel at an angle relative to the direction of flow. This allows a suitable seal arrangement to be disposed and maintained between the butterfly plate and the valve body inner surfaces.

Although the above-described angled sealing butterfly valve is quite reliable and robust, it can exhibit certain drawbacks. For example, the angled configuration may not allow the valve to be installed in some space envelopes, unless certain other features are increased in size and/or weight. A zero-angled (or straight-shaft) butterfly valve may be configured to meet numerous space envelopes, but presently known straight-shaft butterfly valves either exhibit undesirably high internal leakage characteristics and/or insufficient pressure capabilities and/or insufficient structural stiffness and/or increased manufacturing costs and weight.

Hence, there is a need for a straight-shaft butterfly valve that exhibits sufficiently low internal leakage characteristics and/or sufficient pressure capabilities and/or sufficient structural stiffness and/or adequate manufacturing costs and weight. The present invention meets one or more of these needs.

### BRIEF SUMMARY

In one embodiment, and by way of example only, a valve assembly includes a valve body, a shaft, a valve element, and a seal element. The valve body has an inner surface that defines a flow channel. The shaft is rotationally mounted on the valve body and extends across the flow channel. The shaft includes a first seal opening and a second seal opening. The first and second seal openings are spaced apart from each other and extend through the shaft. The valve element is coupled to the shaft and is rotatable therewith, and has an outer periphery. The seal element is coupled to the valve element, extends from the outer periphery, and extends through the first and second seal openings.

In another embodiment, an assembly includes a shaft, a valve element, and a seal element. The shaft is configured to be rotationally mounted on a valve body and to extend across a flow channel formed through the valve body. The shaft includes a first seal opening and a second seal opening. The first and second seal openings are spaced apart from each other and extend through the shaft. The valve element is coupled to the shaft, and has an outer periphery. The seal element is coupled to the valve element, extends from the outer periphery, and extends through the first and second seal openings.

In yet another embodiment, a valve assembly includes a valve body, a shaft, a butter fly plate, and a seal element. The valve body has an inner surface that defines a flow channel. At least a portion of the flow channel is disposed symmetrically about a central axis. The shaft is rotationally mounted on the valve body and extends across the flow channel at least substantially perpendicular to the central axis. The shaft includes a first seal opening and a second seal opening. The first and second seal openings are spaced apart from each other and extend through the shaft. The butterfly plate is coupled to the shaft and is rotatable therewith, and has an outer periphery. The seal element is coupled to the butterfly plate, extends from the outer periphery, and extends through the first and second seal openings.

Furthermore, other desirable features and characteristics of the valve assembly and its constituent parts will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is an isometric view of an exemplary physical implementation of an embodiment of a valve assembly according to the present invention;

FIG. 2 is an end view of the valve assembly depicted in FIG. 1;

FIG. 3 is a cross section view of the exemplary valve assembly depicted in FIGS. 1 and 2 taken along line 3-3 in FIG. 2;

FIGS. 4 and 5 depict various views of a physical implementation of an exemplary valve element and shaft that may be used to implement the valve assembly of FIGS. 1-3;

FIG. 6 is a cross section view of the valve element depicted in FIGS. 4 and 5, taken along line 6-6 in FIG. 4, but depicting only the valve element;

FIG. 7 is a cross section view of the valve element and shaft depicted in FIGS. 4 and 5, taken along line 7-7 in FIG. 5;

FIG. 8 is an isometric view of an exemplary physical implementation of the shaft depicted in FIGS. 1-5;

FIG. 9 is a cross section view of the exemplary shaft depicted in FIG. 8, taken along line 9-9 in FIG. 8;

FIG. 10 is an isometric view of an exemplary physical implementation of a shaft that may be used in the valve assembly of FIGS. 1-3; and

FIG. 11 is a partial cross section view taken along line 11-11 in FIG. 2.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. In this regard, although the valve described and claimed herein is preferably configured for implementation into an aircraft bleed air system, it will be appreciated that it may be implemented in any one of numerous other systems, not just bleed air systems, and in numerous other environments, not just aircraft.

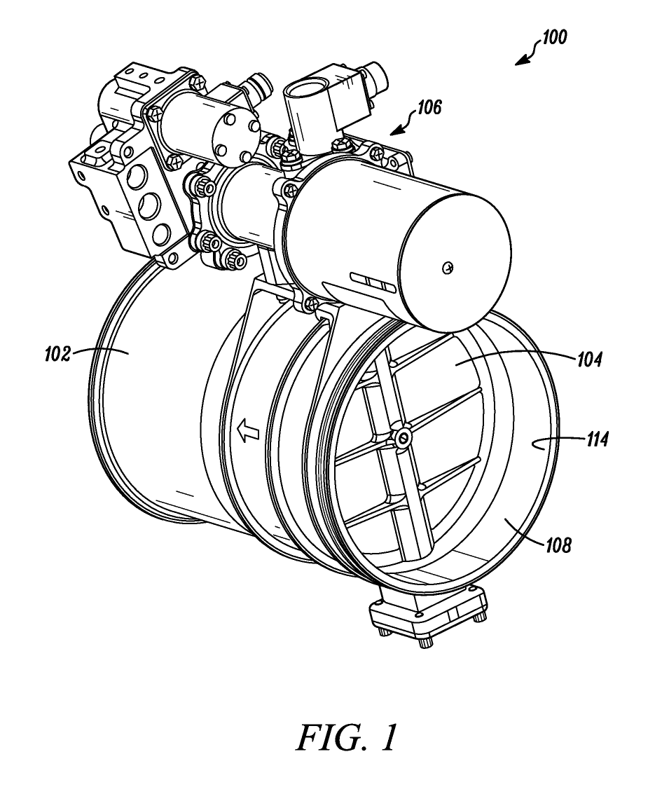

Turning now to FIGS. 1-3, various views of a particular physical implementation of one embodiment of a valve assembly 100 are depicted. The valve assembly 100 includes a valve body 102, a valve element 104, and a valve actuator 106. The valve body 102 includes an inlet port 108, an outlet port 112, and inner surface 114 that defines a flow channel 116. When the valve assembly 100 is appropriately installed within a fluid system (not-illustrated), fluid selectively flows into the inlet port 108, through the flow channel 114, and out the outlet port 112. The capability for fluid to flow into and through the flow body will depend, as may be appreciated, upon the position of the valve element 104.

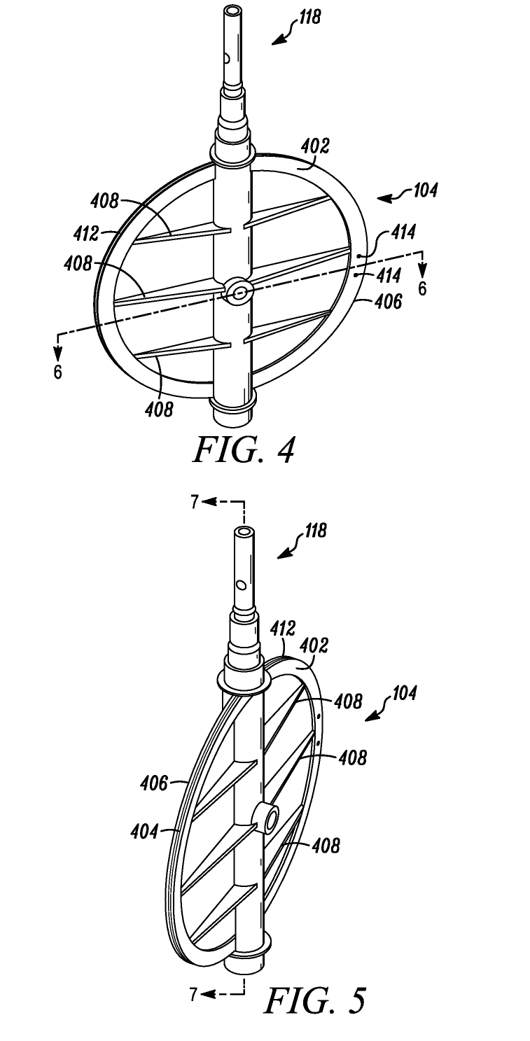

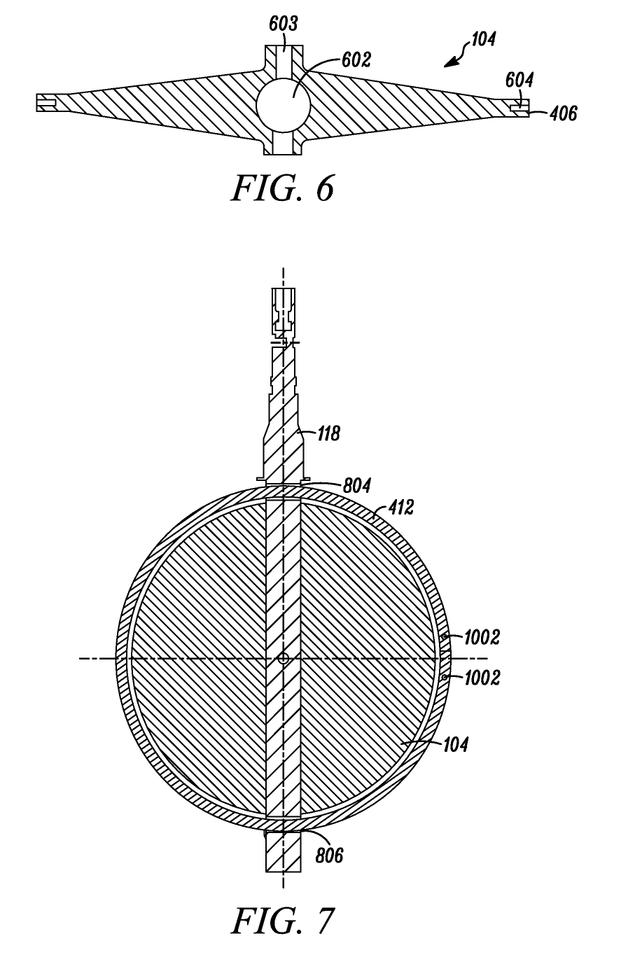

The valve element 104 is disposed within the flow channel 116 and, as is depicted most clearly in FIG. 3, is coupled to a shaft 118. The shaft 118 is rotationally mounted on the valve body 102 and extends across the flow channel 116. More specifically, and with continued reference to FIG. 3, it is seen that at least a portion of the flow channel 116 is disposed symmetrically about a central axis 302, and that the shaft 118 extends through a shaft opening 602 (see FIG. 6) in the valve element 104 and across the flow channel 116 at least substantially perpendicular to the central axis 302. It should be noted that although the entirety of the flow channel 116 in the depicted embodiment is disposed symmetrically about the central axis 302, in other embodiments only a portion of the flow channel 116 may be thusly disposed. In any case, the shaft 118 is rotationally mounted on the valve body 102 via at least a first bearing 304 and a second bearing 306. As FIG. 3 further depicts, additional hardware including, but not limited to, a bias spring, one or more seals, retainers, spacers, and gaskets, may be used to rotationally mount the shaft 118 on the valve body 102. A discussion of this additional hardware is not needed to fully describe or enable the claimed invention, and as such will not be provided.

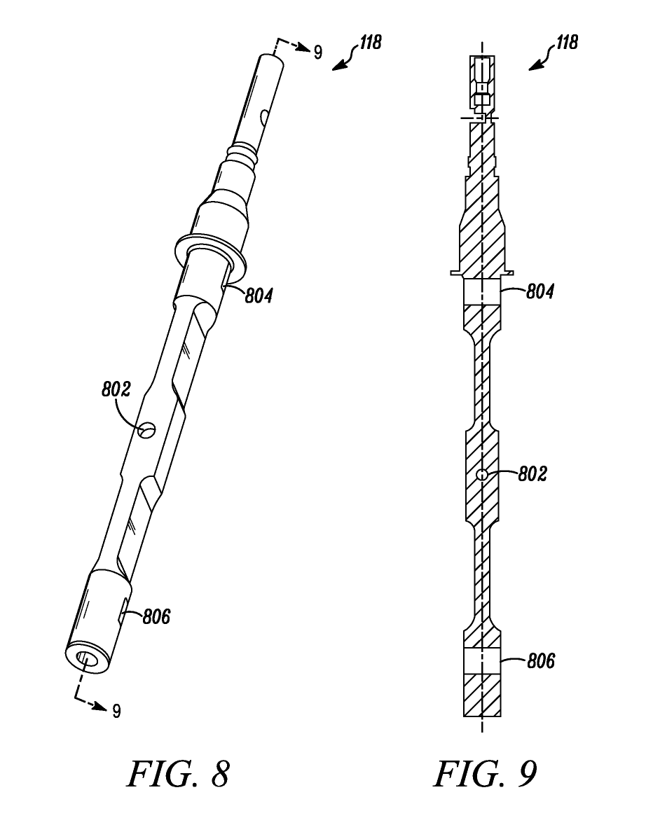

The valve element 104, as was noted above, is coupled to the shaft 118. The valve element 104 is thus rotated with the shaft 118 between a closed position and any one of a plurality of open positions. In the closed position, which is the position depicted in FIGS. 1-3, fluid flow through the flow channel 116 is prevented (or at least substantially prevented). Conversely, when the valve element 104 is rotated to an open position fluid flow through the flow channel 116 is not prevented. The fluid flow rate through the valve body 102 may be at least somewhat controlled by appropriately positioning the valve element 104. In most implementations, however, the valve element 104 is rotated between the closed position and a single, full open position, rather than one or more of a plurality of intermediate open positions. It will nonetheless be appreciated that this is merely exemplary of a preferred embodiment, and that the valve assembly 100 could be configured such that the valve element 104 is moved to a plurality of intermediate open positions, if needed or desired. It will additionally be appreciated that the manner in which the valve element 104 is coupled to the shaft 118 may vary. In the depicted embodiment, however, suitable fastener hardware, such as a setscrew 308 and self-locking nut 312, are used. It is thus seen that the valve element 104 and shaft 118 each include a fastener opening 603 (see FIGS. 6) and 802 (see FIG. 8), respectively, through which the fastener hardware extends.

The valve actuator 106 is coupled to the shaft 118. The valve actuator 106 is configured to supply a drive torque to the shaft 118, which rotates and in turn causes the valve element 104 to rotate to the closed or open position. It will be appreciated that the valve actuator 106 may be variously configured to implement this functionality. In the depicted embodiment, however, the valve actuator 106 is implemented as an electrically-actuated, fluid-operated device. The valve actuator 106 is additionally configured, via a suitable spring mechanism, to bias the valve element 104 toward the closed position. A discussion of the specific configuration and implementation of the valve actuator 104 is not needed to fully describe or enable the claimed invention, and will thus not be provided.

Turning now to FIGS. 4 and 5, a particular preferred embodiment of the valve element 104 and shaft 118 are depicted. The valve element 104 is configured as a butterfly plate and, in addition to the shaft opening 602 and above-mentioned fastener opening 603, includes a first side 402, a second side 404, and an outer periphery 406. The first and second sides 402, 404 are each configured with a plurality of ribs 408 that improve the structural strength of the valve element 104. It will be appreciated that this is merely exemplary, and that the valve element 104 could be configured without the ribs 408 in some embodiments.

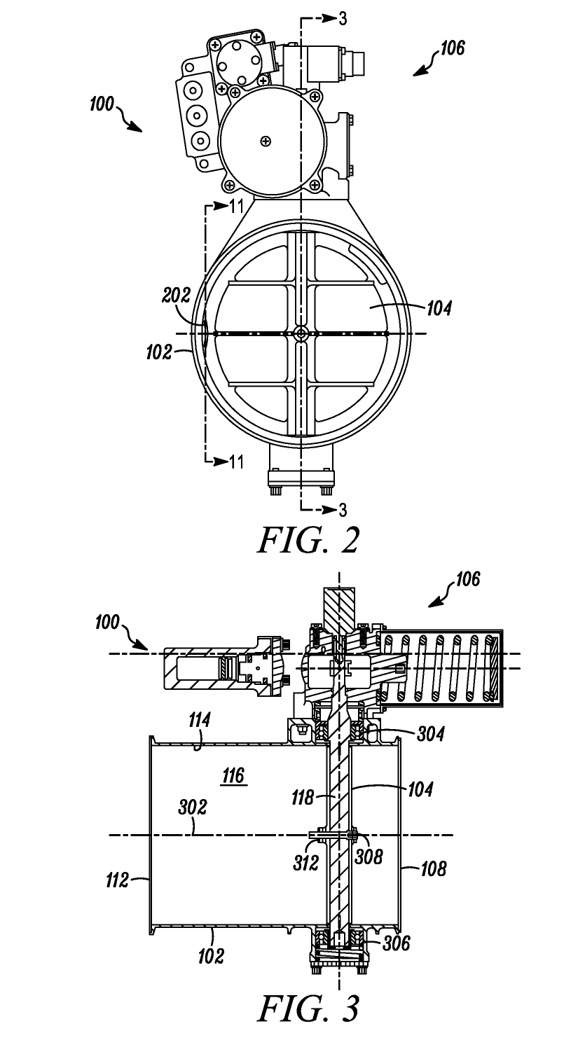

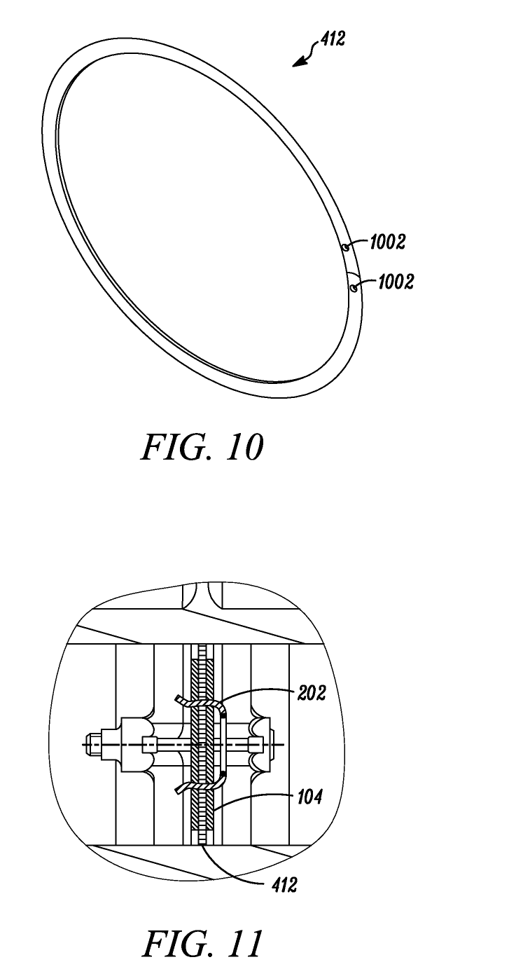

It is additionally seen that a seal element 412, an embodiment of which is depicted in FIG. 10, is coupled to the valve element 104 and extends from the outer periphery 406. The seal element 412 could be coupled to the valve element 104 using any one of numerous techniques. However, in the depicted embodiment, and with reference to FIG. 6, it is seen that a seal groove 604 is formed in the outer periphery 406 of the valve element 104. The seal element 412 is retained within the seal groove 604 using a suitable retainer, which in the depicted embodiment is a retainer clip 202 (see FIG. 2). With reference to FIGS. 4, 10, and 11, it is seen that the retainer clip 202 extends through a first plurality of retainer openings 414 that are formed in and extend through the valve element 104, and a second plurality of retainer openings 1002 that are formed in and extend through the seal element 412. The seal element 412 may be formed of any one of numerous types of materials. Preferably, however, it is formed of a relatively hard metallic material such as, for example, a cobalt alloy.

In order for the seal element 412 to extend around the entire outer periphery 408 of the valve element 104, the seal element 412 also extends through the shaft 118. To facilitate this, as shown most clearly in FIGS. 8 and 9, the shaft 118 includes a first seal opening 804 and a second seal opening 806 that are spaced apart from each other. The first and second seal openings 804, 806 are, at least in the depicted embodiment, configured as slots. It will be appreciated, however, that this is merely exemplary and that various other configurations could be used. No matter the particular configuration of the first and second seal openings 804, 806, it is seen in FIG. 7 that the seal element 412 extends through the first and second seal openings 804, 806.

With the configuration disclosed herein the structural rigidity and stiffness of the valve element 104 is not compromised and any internal leakage that may occur is commensurate with that of an angled butterfly shaft valve. The valve assembly 100 simultaneously provides the weight and envelope benefits of a non-sealing straight shaft butterfly valve. The valve assembly 100 may also be assembled relatively easily, as will now be described.

The valve assembly 100 is preferably assembled by first installing the valve element 104 into the valve body 102. The shaft 118 is then inserted into the valve body 102, and down through the valve element shaft opening 602. When the fastener opening 802 in the shaft 118 lines up with the fastener opening 603 in the valve element 104, the set screw 308 is inserted and tightened onto the shaft 118L, and then the locking nut 312 is tightened onto the set screw 308. The valve element 104 is then centered via appropriate shimming

Once the valve element 104 is centered, the piston ring 412 is fed into the groove 604 around the periphery 408 of the valve element 104, through the first seal opening 804 in the shaft 118, and then continuing around the periphery 408 through the second seal opening 806, and then around until the seal element 412 is fully disposed within the valve element groove 604. The retaining clip 202 is then inserted to hold the seal element in place. Although not depicted in any of the drawings, it will be appreciated that a cut away may be optionally provided on the valve element 104 to ease installation and removal of the seal element.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A valve assembly, comprising:
a valve body having an inner surface that defines a flow channel;
a shaft rotationally mounted on the valve body and extending across the flow channel, the shaft including a first seal opening and a second seal opening, the first and second seal openings spaced apart from each other and extending through the shaft;
a valve element coupled to the shaft and rotatable therewith, the valve element disposed within the flow channel and having an outer periphery; and
a seal element coupled to the valve element and extending from the outer periphery, the seal element extending through the first and second seal openings.

2. The valve assembly of claim 1, wherein:
at least a portion of the flow channel is disposed symmetrically about a central axis; and
the shaft extends across the flow channel at least substantially perpendicular to the central axis.

3. The valve assembly of claim 1, further comprising:
a first plurality of retainer openings extending through the valve element;
a second plurality of retainer openings extending through the seal element; and
a seal retainer extending through each of the first plurality of openings and the second plurality of openings.

4. The valve assembly of claim 1, wherein:
the outer periphery of the valve element has a seal groove formed therein; and
the seal element is partially disposed within, and extends from, the seal groove.

5. The valve assembly of claim 1, wherein the first and second seal openings are each disposed proximate the inner surface of the valve body.

6. The valve assembly of claim 1, wherein the valve element is configured as a butterfly plate.

7. The valve assembly of claim 1, wherein:
the valve element includes a shaft opening, the shaft opening extending through the valve element; and
the shaft extends through the shaft opening.

8. The valve assembly of claim 7, further comprising:
a first fastener opening extending through the valve element;
a second fastener opening extending through the shaft; and
a valve element fastener extending through the first and second fastener openings.

9. The valve assembly of claim 1, wherein:
the valve element is rotatable between a closed position, in which fluid flow through the flow channel is at least substantially prevented, and a plurality of open positions, in which fluid flow through the flow channel is not at least substantially prevented; and
the seal element contacts the valve body inner surface at least when the valve element is in the closed position.

10. The valve assembly of claim 9, further comprising:
a valve actuator mounted on the valve body and coupled to the shaft, the valve actuator configured to selectively supply a torque to the shaft.

11. An assembly, comprising:
a shaft configured to be rotationally mounted on a valve body and extend across a flow channel formed through the valve body, the shaft including a first seal opening and a second seal opening, the first and second seal openings spaced apart from each other and extending through the shaft;
a valve element coupled to the shaft, the valve element having an outer periphery; and
a seal element coupled to the valve element and extending from the outer periphery, the seal element extending through the first and second seal openings.

12. The assembly of claim 11, further comprising:
a first plurality of retainer openings extending through the valve element;
a second plurality of retainer openings extending through the seal element; and
a seal retainer extending through each of the first plurality of openings and the second plurality of openings.

13. The assembly of claim 11, wherein:
the outer periphery of the valve element has a seal groove formed therein; and
the seal element is partially disposed within, and extends from, the seal groove.

14. The assembly of claim 11, wherein the valve element is configured as a butterfly plate.

15. The assembly of claim 11, wherein:
the valve element includes a shaft opening, the shaft opening extending through the valve element; and
the shaft extends through the shaft opening.

16. The assembly of claim 15, further comprising:
a first fastener opening extending through the valve element;
a second fastener opening extending through the shaft; and
a valve element fastener extending through the first and second fastener openings.

17. A valve assembly, comprising:
a valve body having an inner surface that defines a flow channel, at least a portion of the flow channel disposed symmetrically about a central axis;
a shaft rotationally mounted on the valve body and extending across the flow channel at least substantially perpendicular to the central axis, the shaft including a first seal opening and a second seal opening, the first and second seal openings spaced apart from each other and extending through the shaft;
a butterfly plate coupled to the shaft and rotatable therewith, the butterfly plate having an outer periphery; and
a seal element coupled to the butterfly plate and extending from the outer periphery, the seal element extending through the first and second seal openings.

18. The valve assembly of claim 17, wherein:
the outer periphery of the valve element has a seal groove formed therein; and
the seal element is partially disposed within, and extends from, the seal groove.

19. The valve assembly of claim 17, wherein the first and second seal openings are each disposed proximate the inner surface of the valve body.

20. The valve assembly of claim 17, further comprising:
a valve actuator mounted on the valve body and coupled to the shaft, the valve actuator configured to selectively supply a torque to the shaft.
